(19) United States
(12) Patent Application Publication
(10) Pub. No.: US 2023/0306776 A1
(43) Pub. Date: Sep. 28, 2023

(54) METHOD AND DEVICE FOR AUTOMATICALLY ESTIMATING THE BODY WEIGHT OF A PERSON

(71) Applicant: Gestigon GmbH, Luebeck (DE)

(72) Inventors: Christian Strauss, Lübeck (DE); Thomas Klaehn, Lübeck (DE)

(73) Assignee: Gestigon GmbH, Luebeck (DE)

(21) Appl. No.: 18/019,336

(22) PCT Filed: Jul. 28, 2021
(86) PCT No.: PCT/EP2021/071096

§ 371 Date: Feb. 2, 2023

(30) Foreign Application Priority Data
Aug. 5, 2020 (DE) 10 2020 120 600.3

(51) Int. Cl. G06V 40/10; G06T 7/73; G06V 10/764; G06V 20/59; G06V 20/64

(52) U.S. Cl. CPC G06V 40/103; G06T 7/73; G06V 10/764; G06V 20/59; G06V 20/64; G06T 2207/30201; G06T 2200/04; G06T 2207/30268

(57) ABSTRACT

The invention relates to a method for automatically estimating the body weight of a person, comprising the following steps: generating or receiving image data representing an image, captured by an image sensor, of at least one sub-area of the body of a person by means of pixels; classifying at least one subset of the pixels based on a classification, in which different classes each correspond with another body area, wherein the pixels to be classified are each assigned to a determined body area of the person and respective confidence values are determined for these class assignments; for each of at least two of the classes with assigned pixels, calculating a position of at least one reference point, determined according to a specification, for the body area corresponding with this class, based on the pixels assigned to this class; determining a respective distance between at least two of the selected reference points; determining at least one estimation value for the body weight of the person based on a predetermined correlation defining a relationship between different possible distance values and respective body weight values assigned to same; and outputting the at least one estimation value for the body weight of the person. An exclusive selection is made of those pixels used for determining the reference points, based on the respective confidence values of their class assignments using a confidence criterion.

The present invention relates to a method and to a device for automatically estimating a body weight of a person, and to a vehicle, in particular a land vehicle, equipped with such a device.

When it comes to determining the body weight of a person, scales of a wide variety of designs have always been used, these being based on determining the body weight on the basis of a weight force exerted by the body of the person on the scales.

In addition to these conventional methods for determining body weight, newer methods are now also known in which the body weight is estimated on the basis of an image-sensor based recording of the person. In one particularly simple embodiment, the height of the person is for this purpose for example estimated from the image obtained using image sensors and an estimated value for the body weight of the person is determined by way of the comparison table, which correlates the height with a body weight typical for said height.

A method for recognizing poses and for the automatic, software-aided classification of different body areas of a person based on a 3D image of the person is described in the article Jamie Shotto et al., “Real-Time Human Pose Recognition in Parts from Single Depth Images”; Microsoft Research Cambridge & Xbox Incubation, February 2016, available on the Internet at https://www.microsoft.com/en-us/research/wp-content/uploads/2016/02/BodyPartRecognition.pdf

The present invention is based on the object of further improving the achievable reliability and/or accuracy of a body weight determination for a person on the basis of at least one image of the person captured using image sensors.

The object is achieved according to the teaching of the independent claims. Various embodiments and developments of the invention are the subject matter of the dependent claims.

A first aspect of the invention relates to a method, in particular a computer-implemented method, for automatically estimating a body weight of a person. The method comprises the following method steps: (i) generating or receiving image data that represent an image, captured using image sensors, of at least a partial area of the body of a person by way of pixels; (ii) classifying at least a subset of the pixels based on a classification in which different classes each correspond to a different body area, in particular body part, wherein the pixels to be classified are each assigned to a specific body area of the person and respective confidence values are determined for these class assignments; (iii) for each of at least two of the classes occupied with assigned pixels, calculating a position of at least one reference point determined according to a specification, which reference point may in particular be a specific pixel, for the body area corresponding to this class on the basis of the pixels assigned to this class; (iv) determining a respective distance between at least two of the selected reference points; (v) determining at least one estimated value for the body weight of the person based on a predetermined relationship, in particular a mathematical function, which defines a relationship between different possible distance values and body weight values respectively assigned thereto; and (vi) outputting the at least one estimated value for the body weight of the person and optionally the one or more determined distances or positions of the reference points. In the method, an exclusive selection of those pixels that are used to determine the reference points is additionally made on the basis of the respective confidence values of their class assignments using a first confidence criterion.

“Exclusive selection” here means that the pixels that are not selected based on the confidence criterion due to their respective confidence value are not used to determine the reference points. The same applies accordingly to the “exclusive” selections discussed further below with regard to the variables available for selection or to be determined there.

The relationship for determining the estimated value from the one or more relevant distances may be given in particular in the form of a reference table or a database or a calculation formula, in particular a mathematical function.

The use of confidence values as part of the abovementioned method and the exclusive selection, based thereon, of certain pixels, in particular those with high confidence, may be used to improve the reliability (in particular in terms of reliability or robustness of the method) and accuracy of the at least one estimated value that is ultimately determined and output for the body weight of the person.

If more than one estimated value for the body weight is determined and output, this may take place in particular such that these determined estimated values together define an estimated value range. By way of example, the estimation could thereby deliver the result that the estimated body weight is in the range of 70 kg to 71 kg, wherein the value 70 kg represents a first estimated value (lower limit value) and the value 71 kg represents a second estimated value (upper limit value) in this example. It is also conceivable to ascertain and output yet further estimated values, in particular a mean value (for example 70.5 kg here), as further estimated value.

The output may in particular be in a data or signal format that is suitable for further machine processing or use or on a human-machine interface.

The terms “comprises,” “contains,” “includes,” “has,”, “having” or any other variant thereof as may be used herein are intended to cover non-exclusive inclusion. By way of example, a method or a device that comprises or has a list of elements is thus not necessarily limited to those elements, but may include other elements that are not expressly listed or that are inherent in such a method or such a device.

Furthermore, unless expressly stated otherwise, “or” refers to an inclusive or and not to an exclusive “or”. For example, a condition A or B is satisfied by one of the following conditions: A is true (or present) and B is false (or absent), A is false (or absent) and B is true (or present), and both A and B are true (or present).

The terms “a” or “an” as used here are defined in the sense of “one or more”. The terms “another” and “a further” and any other variant thereof should be understood in the sense of “at least one other”.

The term “plurality” as used here should be understood in the sense of “two or more”.

A few preferred embodiments of the method will now be described below, each of which, unless expressly excluded or technically impossible, may be combined as desired with one another and with the further described other aspects of the invention.

In some embodiments, based on the confidence values of the respective pixel assignments of the pixels used to calculate the positions of the reference points, respective confidence values for these positions are ascertained and an exclusive selection of those positions that are used to determine the distances is made based on the respective confidence values of these positions using a second confidence criterion.

Furthermore, in some of these embodiments, based on the confidence values of the respective positions of the reference points used to calculate the distances, respective confidence values for these distances may also be ascertained and an exclusive selection of those distances that are used to determine the at least one estimated value for the body weight may be made based on the respective confidence values of these distances using a third confidence criterion.

The abovementioned embodiments may each be used in particular to increase the reliability and accuracy of the body weight estimation that is able to be performed using the method.

The first, the second and the third confidence criterion may in particular be identical pairwise or as a whole (advantage of simple implementation) or else may be selected differently (advantage of individual adjustability and optimization of the individual steps). By way of example, one or more of the confidence criteria may be defined by way of a respective confidence threshold that defines a respective minimum confidence value required for the use of the associated variable (pixel, reference point position, distance or estimated value for the body weight) as part of the exclusive selection applicable thereto for the performance of the respective following method step.

In some embodiments, a respective confidence value is ascertained
(i) for the position of at least one of the reference points from the confidence values serving as input variables in this regard for the class assignments of the pixels used to determine this position,
(ii) for at least one of the distances from the confidence values serving as input variables in this regard for the positions of reference points used to determine this distance, and/or
(iii) for at least one of the estimated values for the body weight from the confidence values serving as input variables in this regard for the distances of reference points used to determine this estimated value

on the basis of ascertaining a mathematical mean value or extreme value, in particular a minimum value, of the respective confidence values used as input variables in this regard. It is thereby possible to easily determine chains of confidence values that are meaningful and constantly consistent in terms of their confidence statement from the individual confidence values from the respective method steps, which overall deliver usable confidence statements for the at least one estimated value for the body weight that is ultimately determined.

In some embodiments, the position of at least one further reference point that is used to determine a distance and that is not represented by the image data is estimated by extrapolation or interpolation on the basis of other reference points represented by the image data or derived therefrom. It is thereby possible, even in cases in which the image data do not represent a body area relevant for determining the estimated value for the body weight of the person or at least a reference point thereof relevant for this determination of the estimated value, for instance because the reference point lies outside the captured image area or is concealed in the image itself, to still be able to determine the estimated value for the body weight of the person. Such a case may occur in particular if the person adopts a body position that is disadvantageous for the purposes of the method during the image sensor-based capturing of the image data and in the process at least one of the body areas of the person required to determine the estimated value in accordance with the method comes to lie outside the spatial area covered by the captured image. Specifically, in the application case of determining a body weight for a driver or passenger of a vehicle, this may be the case if the driver or passenger leans forward or to the side in their seat, and their posture thus deviates significantly from a normal upright posture on which the image capture is based.

In some of these embodiments, the extrapolation or interpolation takes place on the basis of at least two of the determined reference points located within the image using a body symmetry related to these reference points and the further reference point to be determined (by extrapolation or interpolation). By way of example, a further (third) reference point, which corresponds to a position on one of the two shoulders of the person, may be determined by way of extrapolation or interpolation using the known symmetry property whereby mutually corresponding points (for example the outer end points thereof) of the two shoulders of a person typically have an approximately equal distance from the centrally running body axis, on the basis of knowledge of the positions of the corresponding first reference point on the other shoulder and a second reference point located on the body axis. It is thereby possible to perform particularly reliable determination of the respective position of further reference points on the basis of the utilization of symmetry.

In some of the abovementioned embodiments, the method furthermore comprises checking the plausibility of the position of the further reference point determined by extrapolation or interpolation based on a plausibility criterion. In this case, the plausibility criterion relates to a respective distance between this further reference point and at least one of the calculated reference points not involved in the extrapolation or interpolation. By way of example, a distance between the further reference point determined by way of extrapolation or interpolation and another reference point contained in the image may for this purpose be calculated and compared with an associated value or value range, which corresponds to plausible values for such a distance, in order to check the plausibility of the position of the further reference point. It may in particular then be decided on the basis of this check result whether the reference point is used for the further method, whether it is redetermined in an alternative way or whether it is discarded in favor of another available reference point. This makes it possible to further increase the reliability and/or accuracy of the method and in particular to achieve sufficient reliability and accuracy in many cases, even when the person has adopted a body position that is disadvantageous for the method during the image capture.

In some embodiments, the method furthermore comprises correcting the calculated positions of the reference points by adjusting the calculated positions on the basis of a distance or a perspective from which the image was captured using image sensors. In this case, the distances are determined on the basis of the thus-corrected positions of the reference points. It is thus possible to at least partially compensate for distance-dependent and/or perspective-dependent influences on the captured image, in particular in the sense of normalization to a predefined standard view with a predefined distance and predefined perspective, meaning that the further determination of the estimated value for the body weight of the person is able to take place with less dependence on, ideally independently of, the distance or perspective during the image capture. This makes it possible to further increase the reliability and/or accuracy of the method.

In some embodiments, the method furthermore comprises preprocessing the image data as part of image processing preceding the classification in order to improve the image quality. This image processing may in particular comprise noise suppression (regarding image noise), removal of the image background or parts thereof or removal of other image components irrelevant to the further method steps. The further method steps may thus take place on the basis of image data optimized as part of the image processing, and influences of disruptive or irrelevant image content may be reduced or even eliminated, which in turn may be used to increase the achievable reliability and/or accuracy of the method.

In some embodiments, at least one of the selected reference points for a specific class is determined as or on the basis of the position of a calculated centroid of the pixels assigned to the body area corresponding to the class. The centroid may in this case be defined in particular as a geometric centroid. The calculated position of the centroid may in particular correspond to the position of a pixel represented by the image data, although this would not be absolutely necessary. If the reference point is determined on the basis of the position of a calculated centroid, this may be achieved in particular by averaging the positions of multiple other reference points, which in turn may in particular each be centroids of an associated body area in the image represented by the image data. By way of example, a reference point to which the image is intended to correspond to a point on the body axis of the person may be calculated by averaging the positions of two centroids that relate specifically to the corresponding body areas on the left and right half of the body, respectively (for example centroids of the left torso area and of the right torso area of the person). One advantage of using centroids of defined image areas is that these are able to be calculated efficiently and with high accuracy using known methods, which in turn may have a positive effect on the efficiency of the method and its accuracy and reliability.

In some embodiments, at least one of the selected reference points for a specific class is determined as or on the basis of the position of a pixel on a contour of the body area represented by the assigned pixels and corresponding to the class. The pixel on the contour may in particular correspond to an extreme point of the contour. By way of example, the pixel, in each case in the image of the person, may be the top of the head or the outer ends of the shoulders, or the bottom (that is to say near the legs) end of the torso of the person. This makes it possible to expand the range of available reference points and in particular also to combine them with the abovementioned centroids, in order thus to have reference points available for selection for a broader range of possible body positions (poses) of the person, each optimized with regard to the reliability and accuracy of the method.

In some embodiments, the at least one selected reference point is defined as a point that corresponds, in the image of the person represented by the image data, to one of the following points on the body of the person: (i) a top of the head; (ii) a point on each shoulder that is highest or furthest from the body axis of the person; (iii) a point of the torso nearest the top of the legs; (iv) a lap point determined on the basis of the left and right points of the torso closest to the top of the legs on the respective side with respect to the body axis; (v) a reference point on the torso ascertained on the basis of the centroid of the area of the torso lying on the corresponding half of the body to the left or right with respect to the body axis or a reference point ascertained on the basis of multiple such centroids; (vi) a point at the location of an eye or on a straight line connecting the eyes. The common feature of all of these reference points is that they are typically recognized with a high level of reliability as distinctive points within an image sensor-based image and their positions are able to be determined with corresponding accuracy.

In some of these embodiments, a sitting height of the person is determined as a distance used to determine the estimated value. For this purpose, each of the following individual distances between each two associated reference points are calculated, and these calculated distances are added together to determine a value for the sitting height: (i) distance between a point closest to the top of the legs or the lap point and a centroid, in particular geometric centroid, of the lower torso located below the lowermost costal arch of the person; (ii) distance between the centroid of the lower torso and a centroid of the upper torso located above the lowermost costal arch of the person; (iii) distance between the centroid of the upper torso and a point on the connecting line between the two points on each of the two shoulders that is highest or furthest from the body axis of the person; (iv) distance from the point on the connecting line between the two shoulders and the top of the head. One advantage of these embodiments is that reliable and relatively accurate determination of the sitting height of the person is possible even if the person was in a body position deviating from a straight, upright sitting posture, in particular in a bent body position, during the image acquisition. These embodiments may thus also be used to further increase the achievable accuracy and reliability of the method as a whole.

In some embodiments, a sitting height of the person and a shoulder width of the person are used as two of the distances used to determine the estimated value. These embodiments may be used advantageously in particular in application cases in which it should be expected that the person is seated during the image acquisition, as is typically the case for instance with a driver or passenger in a vehicle, in particular in a motor vehicle. It is possible inter alia for exactly two of the distances, in particular exclusively the sitting height and the shoulder width of the person, to be used as distances for determining the estimated value for the weight of the person. It has been found that using precisely these two special distances as part of the method regularly, that is to say for a large number of different body positions of the person, leads to a particularly reliable and precise estimation of the weight of the person.

In some embodiments, a plurality of preliminary values for the body weight are determined on the basis of various ones of the determined distances, and the at least one estimated value for the body weight is calculated by mathematically averaging the preliminary values. The mathematical averaging operation may in this case in particular be an arithmetic, a geometric or a quadratic averaging operation, in each case with or without weighting, or a median formation, or comprise same (the same also applies in each case below if an averaging operation or mean calculation is mentioned). The use of such a mathematical averaging operation based on a plurality of provisionally estimated values for the body weight of the person may be used to increase the mathematical robustness of the weight estimation method and thus in turn its reliability and accuracy. As part of an optional weighting operation, the relative influence of various input variables of the respective averaging operation on the result of the averaging operation may in particular be adjusted and optimized in a targeted manner. By way of example, in the averaging operation to determine an estimated value for the body weight, a provisional value for the body weight determined on the basis of an ascertained sitting height may thus be weighted to a greater or lesser extent than a provisional value for the body weight determined on the basis of an ascertained shoulder width.

In some embodiments, the reference data used to determine the estimated value for the body weight are selected from multiple available sets of reference data on the basis of one or more previously captured characteristics of the person. These characteristics may relate in particular to an ethnicity or region of origin, an age or a gender of the person. Since such characteristics in many cases clearly correlate with the characteristics of a frequency distribution for body weight, the reliability and accuracy of the method may thereby likewise be further increased. If for example the person is already elderly and thus comes from an age cohort with a birth year that is significantly earlier than today, it may be assumed from a modern standpoint that the body weight distribution, similar to the body height distribution for this age cohort, will shift to smaller values compared to the corresponding values of a considerably younger age cohort, because in recent decades, at least in most industrialized countries, people have become taller and heavier on average.

In some embodiments, the comparison takes place based on the at least one determined distance with the reference data using a regression method, which may in particular be a quadratic or exponential regression method, since the latter have proven to be particularly suitable methods for this comparison. Linear regression methods may also be used in principle, although the abovementioned quadratic and exponential regression methods are often even more suitable for said comparison.

In some embodiments, the image data represent the image sensor-based recording in three spatial dimensions. This may be achieved in particular by using the image data that have been captured by a 3D image sensor (3D camera). The 3D image sensor may in particular be what is known as a time-of-flight (TOF) camera. The use of such three-dimensional image data has the particular advantage over the use of 2D image data that the positions of the reference points and their distances are able to be determined directly on the basis of the image data in three-dimensional space and no loss of accuracy due to the use of only two-dimensional image data has to be accepted, or no effort has to be made to combine multiple 2D images recorded from different perspectives.

In some embodiments, the method furthermore comprises outputting a respective value for at least one of the determined distances or for a respective position of at least one of the determined reference points. In addition to the at least one estimated value for the body weight, said anthropometric information may thus also be made available, in particular including for the purpose of machine-based or automatic further processing.

In some embodiments, the method furthermore comprises controlling (in particular activating, deactivating, controlling or regulating or adjusting) at least one component of a vehicle or of another system, in particular a medical system or a body measurement system, on the basis of the output estimated value for the body weight of the person.

In particular, according to some of these embodiments, in the case of a vehicle application, the control may be performed in relation to one or more of the following vehicle components: seat (in particular with regard to sitting height, seat position, backrest adjustment, seat heating), steering device, safety belt, airbag (in particular with regard to airbag filling/target pressure), interior or exterior mirrors, air-conditioning system, communication device, infotainment system, navigation system. The respective control may in particular take place fully automatically or semi-automatically, meaning that the at least one ascertained estimated value for the body weight is used alone or in conjunction with one or more other variables or parameters for the automatic control of one or more vehicle or system components.

In some embodiments, based on the application of one or more of the confidence criteria, in particular a respective empty selection may also be made. The occurrence of such an empty selection may then be used in particular as a stop criterion for stopping or repeating or pausing the method.

A second aspect of the invention relates to a device for automatically estimating a body weight of a person, wherein the device is configured to carry out the method according to the first aspect of the invention.

A third aspect of the invention relates to a vehicle having a device according to the second aspect of the invention. The vehicle may in particular be configured to carry out the method according to the first aspect in the form of one of the embodiments mentioned above with reference to the control of vehicle components on the basis of the at least one ascertained estimated value for the body weight.

A fourth aspect of the invention relates to a computer program comprising instructions that, when the program is executed by a data processing device, prompt the latter to carry out the method as claimed in one of the preceding claims. The data processing device may in particular be provided by the device according to the second aspect of the invention or form part thereof.

The computer program may in particular be stored in a non-volatile data carrier. This is preferably a data carrier in the form of an optical data carrier or a flash memory module. This may be advantageous if the computer program as such is to be handled independently of a processor platform on which the one or more programs are to be run. In another implementation, the computer program may be present as a file on a data processing unit, in particular on a server, and may be downloaded via a data connection, for example the Internet or a dedicated data connection such as for instance a proprietary or local network. The computer program may additionally have a plurality of individual interacting program modules.

The device according to the second aspect or the vehicle according to the third aspect may accordingly have a program memory in which the computer program is stored. As an alternative, the device or the vehicle may also be configured to access a computer program available externally, for example on one or more servers or other data processing units, via a communication connection, in particular in order to exchange therewith data that are used during the course of the method or computer program or represent outputs of the computer program.

The features and advantages explained in relation to the first aspect of the invention also apply correspondingly to the further aspects of the invention.

Further advantages, features and application possibilities of the present invention emerge from the following detailed description in conjunction with the figures,

in which

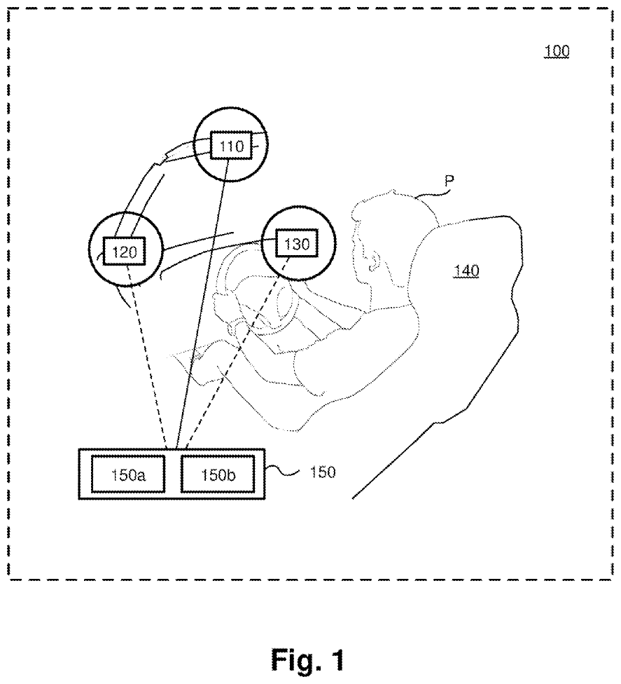

FIG. 1 schematically shows a vehicle according to one embodiment of the invention, having a device for automatically estimating a body weight of a person, in particular a driver of the vehicle;

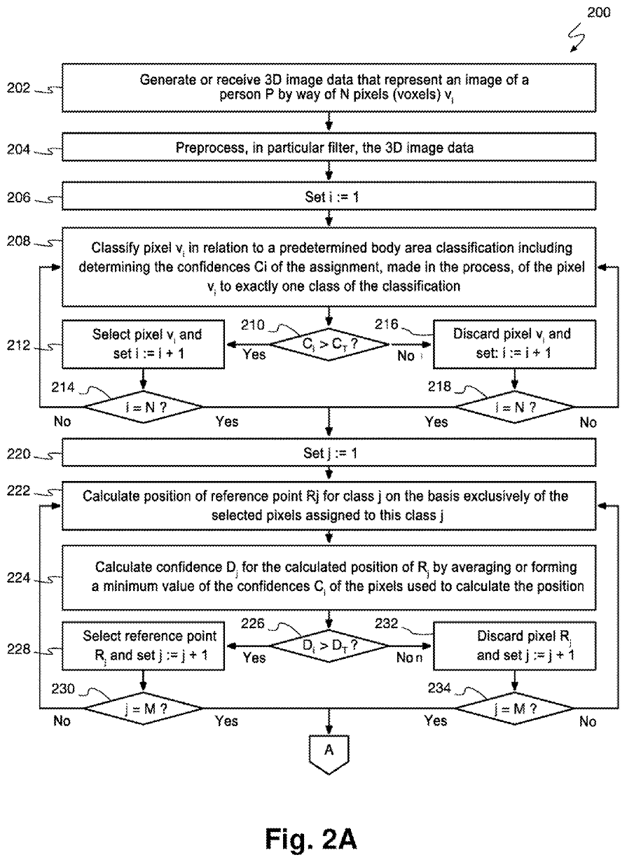

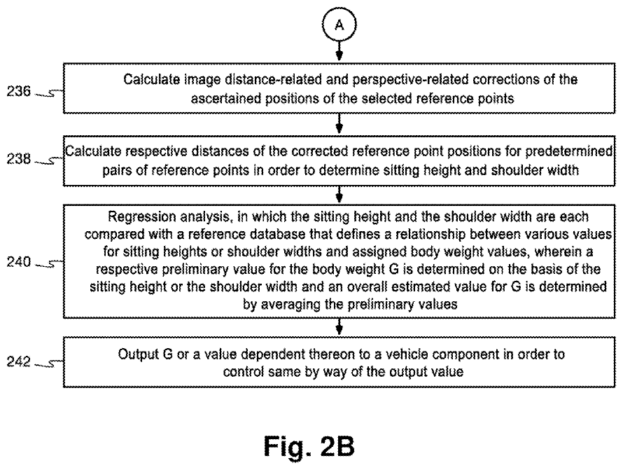

FIG. 2A, 2B show a flowchart for illustrating one embodiment of the method according to the invention;

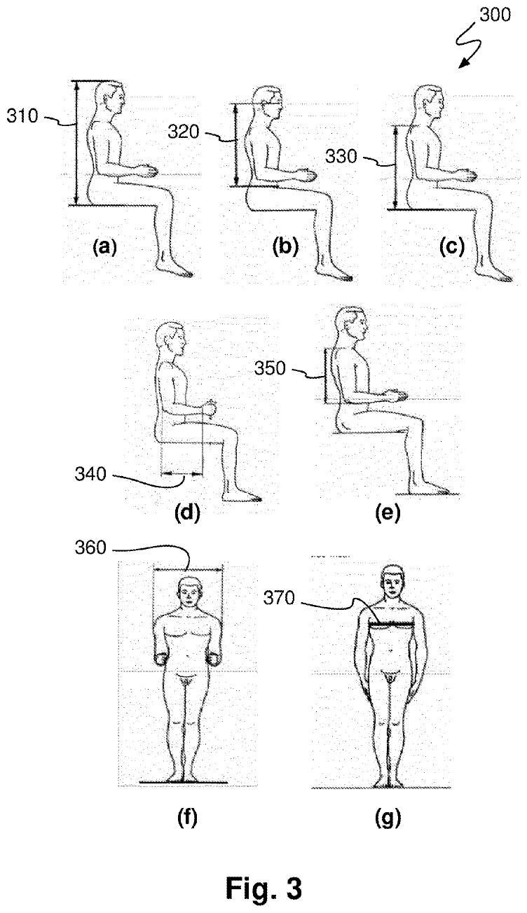

FIG. 3 schematically shows an overview of exemplary anthropometric measures, in particular distances, for measuring the body of a person, which may be used as distances as part of the method;

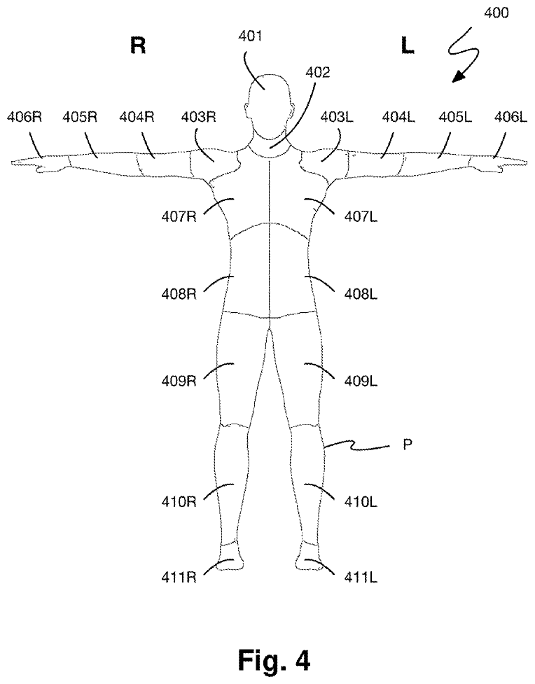

FIG. 4 schematically shows an exemplary classification, according to the method, of body areas of a person as a basis for the weight estimation according to one embodiment of the method according to the invention;

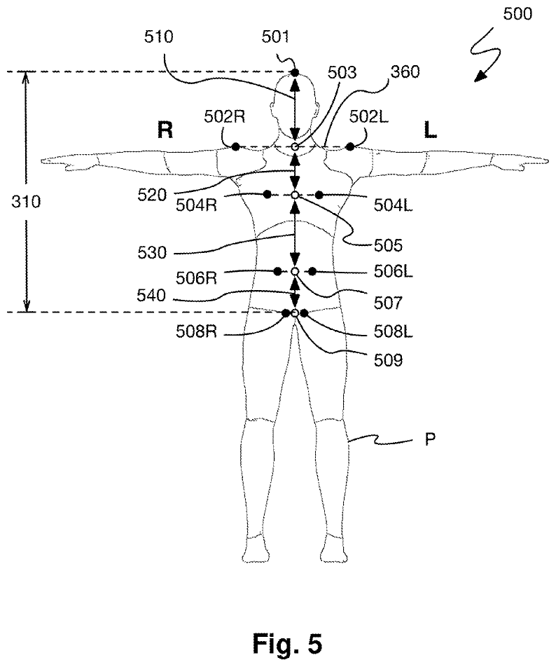

FIG. 5 schematically shows a set of reference points determined with reference to FIG. 3 and associated distances between them as parameters for a weight estimation on the basis of a sitting height calculated from the distances according to one embodiment of the method according to the invention; and

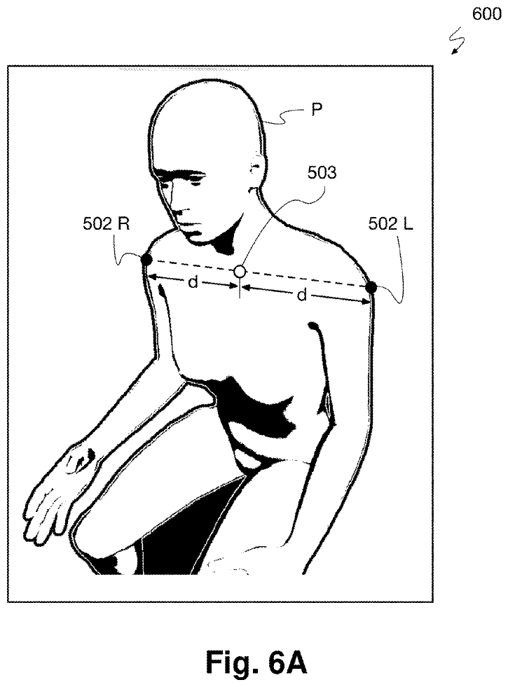

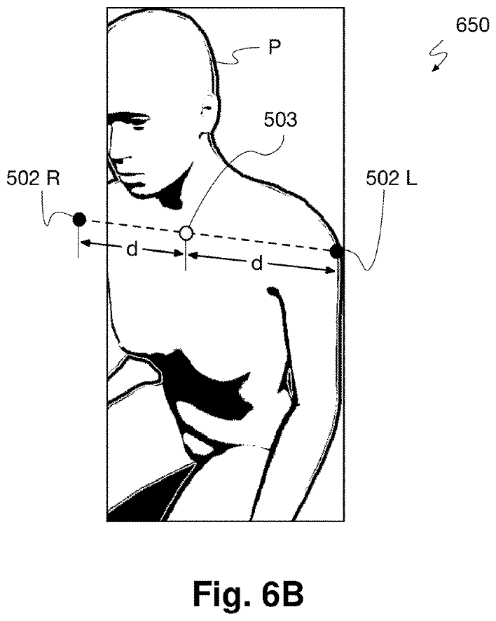

FIG. 6A/6B schematically show an illustration for determining a reference point located outside the image area covered by the image data according to one embodiment of the method according to the invention.

In the figures, the same reference signs are used throughout for the same or corresponding elements of the invention.

FIG. 1 schematically illustrates a vehicle 100 that is equipped with a device 150 for automatically estimating a body weight of a person P according to one embodiment of the invention. The device 150 may in particular be a data processing device (computer), for example in a controller of the vehicle 100. It contains a processor unit 150a and a memory 150b, in which in particular it is possible to store a computer program that is configured to carry out a method according to the invention, for instance in accordance with the embodiment illustrated in FIG. 2.

A person P, who is in particular a driver of the vehicle 100 in the example that is shown, is located on a seat 140 in the vehicle 100. In order to capture the person P using image sensors, one or more image sensors are provided at one or more locations 110, 120 or 130 in or on the vehicle 100. One or more of these image sensors may in particular be 3D cameras, in particular of the time-of-flight (TOF) type, which are able to capture the person P in three spatial dimensions using image sensors and to deliver corresponding image data, which in particular represent a corresponding depth image of the person P.

FIGS. 2A and 2B, connected by a connector A, illustrate an exemplary method 200 according to one embodiment of the invention that is able to be carried out in particular by way of the device 150 from FIG. 1. The method begins, as illustrated in FIG. 2A, with a step 202, in which 3D image data, which represent an image of a person P to be measured in terms of their body weight by way of a number N of 3D pixels (voxels) vᵢ, are received from a corresponding image sensor or from a memory in which such image data are buffer-stored. If the device for performing the method itself has one or more such image sensors, it may also generate the 3D image data itself. One example of such an image is illustrated schematically in FIG. 6B, but as a 2D image, that is to say without the depth information additionally present in a 3D image.

In a further step 204, the 3D image data may be preprocessed, in particular filtered, in order to improve the image quality. Such filtering may in particular serve to reduce or remove image noise or image components that are not required for the rest of the method, such as for example image backgrounds or other irrelevant image components or artefacts. In order to index the individual pixels, a running index i may additionally be set in step 206.

This is then followed by a step 208, in which the preprocessed image data are subjected to a classification method in which each pixel vᵢ is classified with respect to a predetermined body area classification 400, in which different body areas each form a class, that is to say assigned to one of these classes. One exemplary classification is illustrated in FIG. 4, which is discussed below. As part of this classification, for each of the assignments of a respective pixel vᵢ to an associated class, an associated confidence value Cᵢ is additionally determined, this representing a measure of the statistical reliability of the respective assignment. This confidence value of a respective pixel may depend in particular on the confidence that was ascertained when determining the position of this pixel in the three-dimensional image. In particular, TOF cameras typically deliver such confidence values in addition to the actual image data, in particular for a respective depth image.

It is then checked, in a step 210, for the respective pixel vᵢ that has just been classified, whether the associated confidence value Cᵢ satisfies a first confidence criterion, which in the present example is defined as a confidence threshold C_{T}. Only if a confidence value Cᵢ lies above this confidence threshold C_{T}, in a step 212, the associated pixel vᵢ is selected for use in the rest of the method, but if not, it is discarded (step 216). In both cases, a check (i=N?) then takes place as to whether there are still further pixels to be classified (steps 214 or 218). If this is the case (214/218—no), then the classification of the next pixel to the incremented index i=i+1 is continued in step 208.

Otherwise (214/218—yes), in step 220, a further index j is initialized for a number of M classes that are subsequently relevant. Differentiation into relevant and irrelevant classes makes sense in particular when the classification method, in step 208, is performed by way of a classification that makes more classes available than are specifically required to ascertain an estimated value for the weight. This may occur especially when the classes that are not required in this respect are required as part of another application that uses the same classification. Step 220 may also coincide with step 206.

In a step 222 for the current class j, that is to say the assigned body area, a reference point Rⱼ is then calculated according to a corresponding specification and exclusively on the basis of the pixels previously selected in step 212 and assigned to this class j. The specification may in this case specify in particular that the reference point should be calculated as a centroid, in particular volume centroid or geometric centroid, of the set of pixels or pixel positions assigned to the class j in the image. As an alternative, however, the specification may also specify in particular that a specific pixel on the contour of the volume area (surface area in the case of a 2D image) defined by this set of pixels (point cloud) should be selected as reference point RJ. This may in particular be a pixel on the contour that, with regard to at least one of its image coordinates in relation to a coordinate system applied to the image, which does not necessarily have to correspond to the image grid with which the image was recorded, has an extreme value out of all of the pixels located on the contour. Various reference points are illustrated in FIG. 5, which is discussed in detail below, wherein in particular the uppermost shoulder points 502R and 502L and the lower torso points 508R and 508L are each defined in this way by forming extreme values.

Furthermore, in a step 224, a confidence Dⱼ for the calculated position of R_{J} is also calculated, this being able to take place in particular on the basis of averaging or forming a minimum value of the confidences Cᵢ of the selected pixels vᵢ used to calculate this position.

Furthermore, in a step 226, a check is performed for the respective reference point Rⱼ that has just been determined as to whether the associated confidence value Dⱼ satisfies a second confidence criterion, which, in the present example, is defined as a confidence threshold D_{T}. Only if the confidence value Dⱼ lies above this confidence threshold D_{T}, in a step 218, the associated reference point Rⱼ is selected for use in the rest of the method, but if not, it is discarded (step 232). In both cases, a check (i=M?) then takes place as to whether there are still further reference points to be calculated (steps 230 or 234). If this is the case (230/234—no), then the determination of the next reference point to the incremented index j=j+1 is continued in step 222. The method may also be configured such that, if the confidence value Dⱼ of a mandatorily required reference point does not satisfy the second confidence criterion, the method is stopped and run through again at a later time on the basis of new image data. This may in particular also be the case when no pixels or reference points at all satisfy the first or second confidence criterion with their respective confidence values.

With reference now to FIG. 2B, the conclusion of the reference point position determination is followed by a correction step 236, in which the ascertained positions of the selected reference points are calculated on the basis of the average or minimum image distance to the person P that occurred during the image sensor-based capture of the image and the corresponding distance-related or perspective-related corrections to the perspective of the person P selected in the process and applied to the reference points Rⱼ. This makes it possible to compensate for distance-dependent or perspective-dependent influences on the position determination.

Finally, in a step 238, corresponding distances between the associated reference point positions are determined on the basis of the corrected reference point positions for predetermined pairs of reference points. This may in particular take place by calculating one or more distances that individually or cumulatively represent a measure of the sitting height or the shoulder width of the person. FIG. 5, discussed below, illustrates one example for ascertaining these two measures from different distances.

In order to arrive at an estimated value for the body weight of the person P from the distances thus determined, these distances are used, in a step 240, as input variables for a regression analysis or another comparison with data from a database, the data of which define a relationship between different values for the determined measures (in the present example, specifically sitting height or shoulder width), on the one hand, and various body weight values corresponding thereto, on the other hand. There are large numbers of such anthropometric databases, in particular for the respective populations of different countries or regions. By way of example, the Federal Institute for Occupational Safety and Health for Germany provides such a database, in particular including on the Internet.

If, as in the present example, different measures are used as input variables for the regression or database, then a corresponding value, in particular a provisional value, for the estimated body weight G of the person may be determined for each of these variables. These various provisional values may then be combined, in particular by averaging, to form an overall estimated value for the body weight G.

Finally, in a step 242, the determined overall estimated value G may be output, in particular on a human-machine interface, or else, as illustrated in the present example, to a vehicle component of the vehicle 100 in order to control this component by way of the output value. The vehicle component may in particular be an adjustable exterior mirror, an airbag able to be configured or deactivated in different ways, or an adjustable passenger seat.

It is thereby possible to control such controllers, which in the past was not able to be achieved at all or was able to be achieved using dedicated sensors provided for this purpose, in particular scales, on the basis of image data that are in many cases already captured for other applications, meaning that dual-use or multi-use use is made possible with at least a partial saving of application-specific effort or components.

FIG. 3 schematically shows an overview of various exemplary anthropometric measures that may be used in principle as distances for measuring the body of the person P as part of the body weight estimation according to the method. In this case, FIG. 3(a) illustrates a sitting height 310, FIG. 3(b) illustrates an eye level 320, FIG. 3(c) illustrates a shoulder height 330, FIG. 3(d) illustrates a forearm length 340, FIG. 3(e) illustrates an upper arm length 350, FIG. 3(f) illustrates a shoulder width 360, and FIG. 3(g) illustrates a torso width 370.

FIG. 4 schematically illustrates one exemplary classification 400 in which different body areas of a person P each represent a class 401 to 411R. In this case, the letter “R” stands for “right” and the letter “L” stands for “left”. Computer-aided methods for the automatic classification of individual pixels of an image of a person represented by corresponding image data into such body area classifications are known and are described for example in the article by Jamie Shotto et al. cited in the introductory part of the description. In the specific classification 400 from FIG. 4, each is defined as a class (with mutually corresponding right and left body areas each individually forming a class: the head 401, the neck 402, the shoulders 403, the upper arms 404, the forearms 405, the hands 406, the upper torso areas 407, the lower torso areas 408, the thighs 409, the lower legs 410 and the feet 411.

As explained above with reference to FIG. 2A, B, the distances used as part of the method 200 are determined as distances between specific reference points Rⱼ. FIG. 5 illustrates one specific example in which the sitting height 310, on the one hand, and the shoulder distance 360, on the other hand, are intended to be determined as distances.

The following are used as reference points R for this purpose: (i) a top 501 of the head, (ii) the uppermost points 502R/L of the left and right shoulders 403R/L in terms of height and the shoulder centroid 503 determined therefrom by geometric averaging, (iii) the respective centroids 504R/L of the upper right and left torso areas 407R/L and the upper torso centroid 505 determined therefrom by geometric averaging, (iv) the respective centroids 506R/L of the upper right and left torso areas 408R/L and the upper torso centroid 507 determined therefrom by geometric averaging, and (v) the respective lowermost points 508R/L of the lower right and left torso areas 408R/L and the lap point 509 determined therefrom by geometric averaging.

The shoulder width 360 may then be determined easily by calculating the distance between the two reference points 502R and 502L. The sitting height, on the other hand, is calculated cumulatively here, that is to say by individually determining multiple distances and summing them. A first of these distances is the distance 510 between the top 501 of the head and the shoulder centroid 503. A second of these distances is the distance 520 between the shoulder centroid 503 and the upper torso centroid 505. A third of these distances is the distance 530 between the upper torso centroid 505 and the lower torso centroid 507. Finally, a fourth and last of these distances is the distance 540 between the lower torso centroid 505 and the lap point 509. The sitting height that is sought is the sum of these four distances. This division of the sitting height determination on the basis of multiple individual distances has the advantage that it delivers more accurate and more reliable results, especially in the case of body positions that deviate significantly from an upright or straight posture, than a sitting height determination based on directly determining the distance between the reference points 501 and 509 by way of subtraction.

With reference to FIGS. 6A and 6B, the intention is now to highlight the case where the image data do not completely represent or image the body areas of the person P that are relevant for ascertaining the distances. This may occur in particular when the person adopts a body position that deviates from a normal body position or pose for which the image capture is adjusted (for example straight, upright sitting posture).

FIG. 6A shows a scenario 600 in which, with regard to the determination of the shoulder width 360, both the reference point 502R for the right shoulder 403R and the reference point 502L for the left shoulder 403L are represented by the image data. As described above with reference to FIG. 5, the shoulder centroid 503 may thus be determined here by geometrically averaging the positions of these two reference points, such that the respective distances between these reference points and the shoulder centroid 503 are the same and each have the distance value d. The shoulder centroid 503 is therefore located, at least to a good approximation, on the body axis of the person P.

FIG. 6B shows, on the other hand, a scenario 650 in which, with regard to the determination of the shoulder width 360, only the reference point 502L for the left shoulder 403L is represented by the image data, while the area of the right shoulder 403R, which is a mirror image thereof, came to lie outside the image area covered by the image data during the image capture. Here, however, the position of the right shoulder reference point 502R may then be calculated by extrapolation utilizing the known symmetry property from FIG. 6A, according to which the shoulder centroid 503 lies, to a good approximation, on the body axis and the two shoulder reference points 502R and 502L each have the same distance d from the shoulder centroid 503. For this purpose, in addition to the position of the left shoulder reference point 502L located in the image section, the position of the shoulder centroid 503 is estimated on the basis of a position of the body axis, which is likewise estimated on the basis of the image data, and taking into account the image perspective. As part of the extrapolation, the position of the right shoulder reference point 502R along the connecting line through the points 502L and 503 is then estimated by adding twice the connecting vector between the points 502L and 503 to the position of the point 502L on this line. The shoulder width 360 that is sought is thus obtained, in simpler terms, by calculating the distance value d by way of the determined positions of the points 502L and 503 and doubling it.

A plausibility check may additionally also be carried out, in which the position of the shoulder centroid 503 or of the right shoulder reference point 502R is checked using a further reference point. For this purpose, in particular a distance from this reference point may be ascertained and compared with an associated reference distance for the purpose of a check. Distance ratios may also serve as a basis for a plausibility check in a similar way, in addition to or instead of pure distance values.

While at least one exemplary embodiment has been described above, it should be noted that there are a large number of variations in this respect. It should also be noted here that the described exemplary embodiments constitute only non-limiting examples and they are not thereby intended to limit the scope, applicability or configuration of the devices and methods described here. Instead, the above description will provide a person skilled in the art with an indication for the implementation of at least one exemplary embodiment, wherein it is understood that various changes in the means of functioning and the arrangement of the elements described in an exemplary embodiment may be made without in the process departing from the subject matter respectively defined in the appended claims or its legal equivalents.

### LIST OF REFERENCE SIGNS

100 vehicle, in particular automobile
110 first position for image sensor
120 second position for image sensor
130 third position for image sensor
140 seat for person P, in particular driver's seat of a vehicle
150 device for estimating the body weight of a person
150a processor unit
150b memory, in particular program memory
200 method for estimating the body weight of a person P
205-242 method steps of the method 200
300 overview of exemplary anthropometric measures
310 sitting height
320 eye level
330 shoulder height
340 forearm length
350 upper arm length
20 360 shoulder width
370 torso width
400 body area classification
401 head
402 neck
403R, L right (R) or left (L) shoulder
404R, L right (R) or left (L) upper arm
405R, L right (R) or left (L) forearm
406R, L right (R) or left (L) hand
407R, L right (R) or left (L) upper torso
408R, L right (R) or left (L) lower torso
409R, L right (R) or left (L) thigh
410R, L right (R) or left (L) lower leg
410R, L right (R) or left (L) foot
500 overview for defining reference points and distances for determining the sitting height 210
501 top of the head
502R, L uppermost shoulder points
503 centroid of the shoulder points 502
504R,L centroids of the right or left upper torso
505 centroid of the upper torso centroids 504
506R,L centroids of the right or left lower torso
507 centroid of the lower torso centroids 506
508R,L lowermost points of the right or left lower torso
509 lap point, centroid of lowermost torso points 508
510 distance from top 501 to centroid of the shoulder points 503
520 distance from centroid 503 of the shoulder points to centroid 505 of the upper torso area
530 distance from centroid 505 of the upper torso area to centroid 507 of the lower torso area
540 distance from centroid 507 of the lower torso area to lap point 509
600 sketch for determining the centroid 503 of the shoulder points 502R, L
650 sketch for determining the centroid 503 of the shoulder points 502R, L if one of the shoulder points is not represented by the image data
i running index for pixels
j running index for reference points
Cᵢ confidence values of the pixel assignments
C_{T} first confidence criterion (for pixel assignments)
Dⱼ confidence values of the pixel assignments
D_{T} second confidence criterion (for reference point positions)
G estimated value for body weight of the person P
P person whose body weight is to be determined
vᵢ pixels (voxels)

1. A method for automatically estimating a body weight of a person, the method comprising:
generating or receiving image data that represent an image, captured using image sensors, of at least a partial area of the body of a person by way of pixels;
classifying at least a subset of the pixels based on a classification in which different classes each correspond to a different body area, wherein the pixels to be classified are each assigned to a specific body area of the person and respective confidence values are determined for these class assignments;
for each of at least two of the classes occupied with assigned pixels, calculating a position of at least one reference point, determined according to a specification, for the body area corresponding to this class on the basis of the pixels assigned to this class;
determining a respective distance between at least two of the selected reference points;
determining at least one estimated value for the body weight of the person based on a predetermined relationship, which defines a relationship between different possible distance values and body weight values respectively assigned thereto; and
outputting the at least one estimated value for the body weight of the person;
wherein an exclusive selection of those pixels that are used to determine the reference points is made on the basis of the respective confidence values of their class assignments using a first confidence criterion.

2. The method as claimed in claim 1, wherein, based on the confidence values of the respective pixel assignments of the pixels used to calculate the positions of the reference points, respective confidence values for these positions are ascertained and an exclusive selection of those positions that are used to determine the distances is made based on the respective confidence values RDA of these positions using a second confidence criterion.

3. The method as claimed in claim 2, wherein, based on the confidence values RPM of the respective positions of the reference points used to calculate the distances, respective confidence values for these distances are ascertained and an exclusive selection of those distances that are used to determine the at least one estimated value for the body weight is made based on the respective confidence values of these distances using a third confidence criterion.

4. The method as claimed in claim 1, wherein a respective confidence value is ascertained
for the position of at least one of the reference points from the confidence values serving as input variables in this regard for the class assignments of the pixels used to determine this position,
for at least one of the distances from the confidence values serving as input variables in this regard for the positions of reference points used to determine this distance, and/or
for at least one of the estimated values for the body weight from the confidence values serving as input variables in this regard for the distances of reference points used to determine this estimated value,
on the basis of ascertaining a mathematical mean value or extreme value of the respective confidence values used as input variables in this regard.

5. The method as claimed in claim 1, wherein the position of at least one further reference point that is used to determine a distance and that is not represented by the image data is estimated by extrapolation or interpolation on the basis of other reference points represented by the image data or derived therefrom.

6. The method as claimed in claim 5, wherein the extrapolation or interpolation takes place on the basis of at least two of the determined reference points located within the image using a body symmetry related to these reference points and the further reference point to be determined.

7. The method as claimed in claim 5, further comprising:
checking the plausibility of the position of the further reference point determined by extrapolation or interpolation based on a plausibility criterion that relates to a respective distance between this further reference point and at least one of the calculated reference points not involved in the extrapolation or interpolation.

8. The method as claimed in claim 1, further comprising:
correcting the calculated positions of the reference points by adjusting the calculated positions on the basis of a distance or a perspective from which the image was captured using image sensors, wherein the distances are determined on the basis of the thus-corrected positions of the reference points.

9. The method as claimed in claim 1, further comprising:
preprocessing the image data as part of image processing preceding the classification to improve the image quality.

10. The method as claimed in claim 1, wherein at least one of the selected reference points for a specific class is determined as or on the basis of the position of a calculated centroid of the pixels assigned to the body area corresponding to the class.

11. The method as claimed in claim 1, wherein at least one of the selected reference points for a specific class is determined as or on the basis of the position of a pixel on a contour of the body area represented by the assigned pixels and corresponding to the class.

12. The method as claimed in claim 1, wherein the at least one selected reference point is defined as a point that corresponds, in the image of the person represented by the image data, to one of the following points on the body of the person:
a top of the head;
a point on each shoulder that is highest or furthest from the body axis of the person;
a point of the torso nearest the top of the legs;
a lap point determined on the basis of the left and right points of the torso closest to the top of the legs on the respective side with respect to the body axis;
a reference point on the torso ascertained on the basis of the centroid of the area of the torso lying on the corresponding half of the body to the left or right with respect to the body axis or a reference point ascertained on the basis of multiple such centroids;
a point at the location of an eye or on a straight line connecting the eyes.

13. The method as claimed in claim 12, wherein a sitting height of the person is determined as a distance used to determine the estimated value and, for this purpose, each of the following individual distances between each two associated reference points are calculated, and these calculated distances are added together to determine a value for the sitting height:
distance between a point closest to the top of the legs or the lap point and a centroid of the lower torso located below the lowermost costal arch of the person;
distance between the centroid of the lower torso and a centroid of the upper torso located above the lowermost costal arch of the person;
distance between the centroid of the upper torso and a point on the connecting line between the two points on each of the two shoulders that is highest or furthest from the body axis of the person;
distance from the point on the connecting line between the two shoulders and the top of the head.

14. The method as claimed in claim 1, wherein a sitting height of the person and a shoulder width of the person are used as two of the distances used to determine the estimated value.

15. The method as claimed in claim 1, wherein a plurality of preliminary values for the body weight are determined on the basis of various ones of the determined distances, and the at least one estimated value for the body weight value is calculated by mathematically averaging the preliminary values.

16. The method as claimed in claim 1, wherein the reference data used to determine the estimated value for the body weight are selected from multiple available sets of reference data on the basis of one or more previously captured characteristics of the person.

17. The method as claimed in claim 1, wherein the comparison takes place based on the at least one determined distance with the reference data using a regression method.

18. The method as claimed in claim 1, wherein the image data represent the image sensor-based recording in three spatial dimensions.

19. The method as claimed in claim 1, further comprising: outputting a respective value for at least one of the determined distances or for a respective position of at least one of the determined reference points.

20. The method as claimed in claim 1, further comprising:
controlling at least one component of a vehicle or of another system on the basis of the output estimated value for the body weight of the person.

21. The method as claimed in claim 20, wherein the control is performed in relation to one or more of the following vehicle components: seat, steering device, safety belt, airbag, interior or exterior mirrors, air-conditioning system, communication device, infotainment system, navigation system.

22. A device for automatically estimating a body weight of a person, wherein the device is configured to carry out the method claimed in claim 1.

23. (canceled)

24. A computer program comprising instructions that, when the program is executed by a data processing device, prompt the latter to carry out the method as claimed in claim 1.
